(19) United States
(12) Patent Application Publication
(10) Pub. No.: US 2007/0043869 A1
(43) Pub. Date: Feb. 22, 2007

(54) Job management system, job management method and job management program

(75) Inventor: Dai Harabe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/504,094

(22) Filed: Aug. 15, 2006

(30) Foreign Application Priority Data
Aug. 18, 2005 (JP) 237948/2005

(51) Int. Cl. G06F 15/173

(52) U.S. Cl. 709/226

(57) ABSTRACT

A job management system of the present invention includes a first processor element which receives a job flow and a second processor element. The first processor element includes a first element which generates first and second virtual hosts. The first and second virtual hosts correspond to the first and second processor elements, respectively, and execute a job. The first processor element also includes a second element which, as the first virtual host, allocates the jobs of the job flow to the first and second virtual hosts and which merges the results of the execution by the first and second virtual hosts.

### BACKGROUND OF THE INVENTION

1. Field of the Invention

The present invention relates to a job flow management system, a job management method, and a job management program, and more particularly to a job flow management system, a job management method, and a job management program for executing jobs of the job flow using a plurality of CPUs.

2. Description of the Related Art

Conventionally, as described in Japanese Patent Application Laid-Open No. H10-222383 or Japanese Patent Application Laid-Open No. 2000-268011, for example, job management systems in which a plurality of CPUs are operating, are provided with a scheduling function, a job transfer function, a job execution function, and a job flow control function. In such job management systems, when a scheduled time is reached, an analysis on parallel execution or exclusive control of jobs are made from a job flow, and the jobs are transferred to machines designated based on the result of the analysis. Then, thejobsareexecutedbythemachinestowhich they were transferred.

In the conventional job management systems, however, because the exclusive control of the job flows or the control of the number of the job flows which concurrently executed is carried out by job flow control threads, the number of the job flow control thread which the job management system uses for performing flow control has to be one. Because CPUs are assigned to the job flow control threads on a one-to-one basis, the job management system can use a single CPU only even if it has a plurality of CPUs, thereby, this has caused inconvenience that desired enhancement in processing speed cannot be achieved.

### SUMMARY OF THE INVENTION

An object of the present invention is to provide a job management system, a job management method, and a job management program which can improve the inconvenience as described above and can increase the job processing speed in the job management system by efficient use of a plurality of CPUs.

According to one aspect of the present invention, a job management system is provided which includes: a first processor element which receives a job flow; and a second processor element, wherein the first processor element includes: a first element which generates first and second virtual hosts, wherein the first and second virtual hosts correspond to the first and second processor elements, respectively, and execute a job; and a second element which, as the first virtual host, allocates the jobs of the job flow to the first and second virtual hosts and which merges the results of the execution by the first and second virtual hosts. This structure allows first and second virtual hosts, wherein first and second virtual hosts correspond, respectively, to first and second processor elements, to execute jobs of job flow. Thereby this structure can realize the efficient use of the processor elements and the improvement of the job processing speed.

According to another aspect of the present invention, a method of managing jobs between a first processor element which receives a job flow and a second processor element is provided which includes: generating, by the first processor element, first and second virtual hosts, wherein the first and second virtual hosts correspond to the first and second processor elements, respectively, and execute a job; allocating, by the first processor element as the first virtual host, the jobs of the job flow to the first and second virtual hosts; and merging, by the first processor element as the first virtual host, the results of the execution by the first and second virtual hosts. This method allows first and second virtual hosts, wherein first and second virtual hosts, respectively, correspond to first and second processor elements, to execute jobs of job flow. Thereby this method can realize the efficient use of the processor elements and the improvement of the job processing speed.

According to another aspect of the present invention, a computer readable medium recording thereon a program for enabling a first computer element to execute a job management method which manages a job between the first processor element which receives a job flow and a second processor element, the job management method is provided which includes: generating, by the first processor element, first and second virtual hosts, wherein the first and second virtual hosts correspond to the first and second processor elements, respectively, and execute a job; allocating, by the first processor element as the first virtual host, the jobs of the job flow to the first and second virtual hosts; and merging, by the first processor element as the first virtual host, the results of the execution by the first and second virtual hosts. This program allows first and second virtual hosts, wherein first and second virtual hosts correspond, respectively, to first and second processor elements, to execute jobs of job flow. Thereby this program can realize the efficient use of the processor elements and the improvement of the job processing speed.

As described above, according to the present invention, a job management system, a job management method, and a job management program can be provided that make it possible to operate, efficiently, a plurality of CPUs, thus unprecedented and superior job management system, job management method, and job management program can be provided, thereby the present invention can improve the job processing speed.

### BRIEF DESCRIPTION OF THE DRAWINGS

Other features and advantages of the invention will be made more apparent by the following detailed description and the accompanying drawings, wherein:

FIG. 1 is a block diagram illustrating the structure of a job management system according to an embodiment of the present invention;

FIG. 2 is a block diagram illustrating the correspondence between the CPUs shown in FIG. 1 and job flow control threads generated in hosts;

FIG. 3 illustrates storage areas contained in the memory shown in FIG. 1;

FIG. 4 illustrates an execution information table stored in the shared data area of FIG. 3;

FIG. 5 is a block diagram illustrating the functional structure of the job management system generated by executing the job flow control threads in FIG. 2;

FIG. 6 is a flow chart illustrating the operation of the job management system according to the embodiment of the present invention;

FIG. 7 is a block diagram illustrating the correspondence of job flow control threads in a job management system according to a second embodiment of the present invention; and

FIG. 8 is a block diagram illustrating the functional structure of the job management system according to the second embodiment generated by executing the job transfer thread and the job flow control threads in FIG. 7.

In the drawings, the same reference numbers represent the same structural elements.

### DETAILED DESCRIPTION OF THE PREFERRED EMBODIMENTS

A first embodiment of the present invention will be described in detail below.

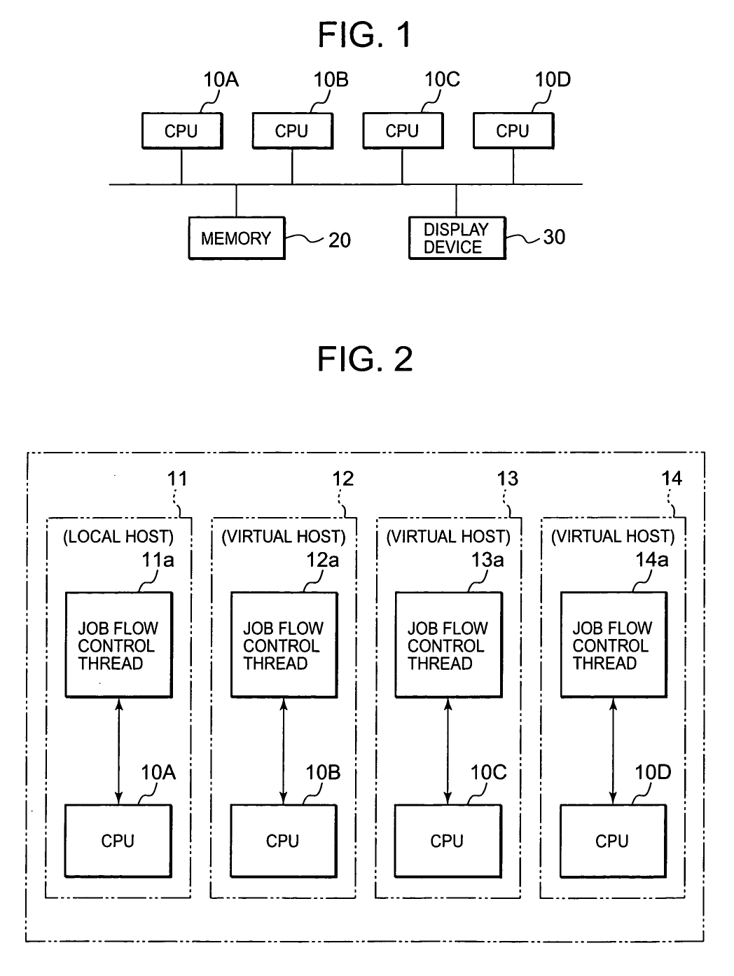

Referring to FIG. 1, a job management system manages jobs using a plurality of central processing units (CPUs) . The job management system includes a plurality of CPUs 10A, 10B, 10C and 10D, a memory 20 and a display device 30.

Referring to FIGS. 1 and 2, the memory 20 previously stores a virtual host generation program. In this embodiment, by CPU 10A's executing the virtual host generation program on the plurality of CPUs 10A to 10D, a local host 11 and a plurality of virtual hosts 12, 13 and 14 are generated (Generation of Virtual Hosts). The local host 11 corresponds to CPU 10A, the virtual host 12 corresponds to CPU 10B, the virtual host 13 corresponds to CPU 10C and the virtual host 14 corresponds to CPU 10D. The local host 11 is a virtual host for job management. The virtual hosts 12, 13 and 14 are used for processing jobs. In this embodiment, three virtual hosts are generated. In other words, in this embodiment, a job management system manages and executes a job flow using a plurality of CPUs 10A to 10D, CPU 10A which is a local host 11 has a virtual host generation function. The CPU 10A also has a function as a virtual host for job management 11 which allocates the execution contents of the job flow described above to the generated virtual hosts 12 to 14 and which collects the processing results.

The local host 11 has a job flow control thread 11a that corresponds to the CPU 10A on a one-to-one basis. The job flow control thread 11a is executed on CPU 10A. The virtual host 12 has a job flow control thread 12a that corresponds to the CPU 10B on a one-to-one basis. The job flow control thread 12a is executed on CPU 10B. The virtual host 13 has a job flow control thread 13a that corresponds to the CPU 10C on a one-to-one basis. The job flow control thread 13a is executed on CPU 10C. The virtual host 14 has a job flow control, thread 14a that corresponds to the CPU 10D on a one-to-one basis. The job flow control thread 14a is executed on CPU 10D.

The job flow control thread 11a of the local host 11, the job flow control thread 12a of the virtual host 12, the job flow control thread 13a of the virtual host 13, and the job flow control thread 14a of the virtual host 14 have their specific information including,for example, a program counter, a stack pointer, and a register, and are capable of concurrently accessing to the job management program, respectively. The generation of the job flow control threads 11a to 14a means that the specific information, such as a program counter, a stack pointer and/or a register, is stored in the memory 20.

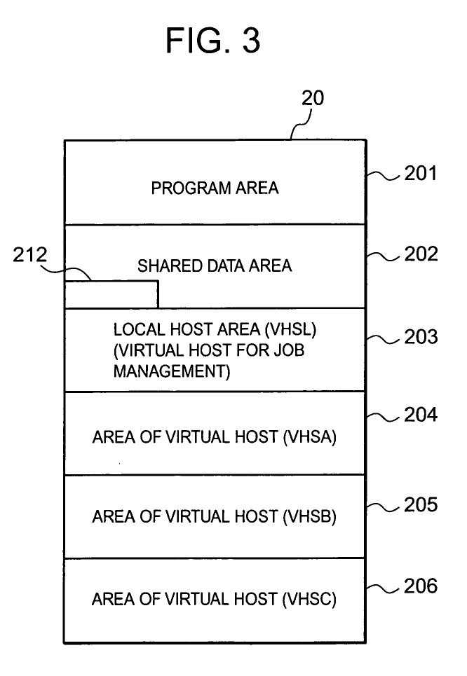

Referring to FIG. 3, the memory 20 has a program area 201, a shared area 202, a local host area (VHSL) 203, an area of a virtual host (VHSA) 204, an area of a virtual host (VHSB) 205, and an area of a virtual host (VHSC) 206. The program area 201 previously stores an operating system (OS), a virtual host generation program, a job management program, and an application program.

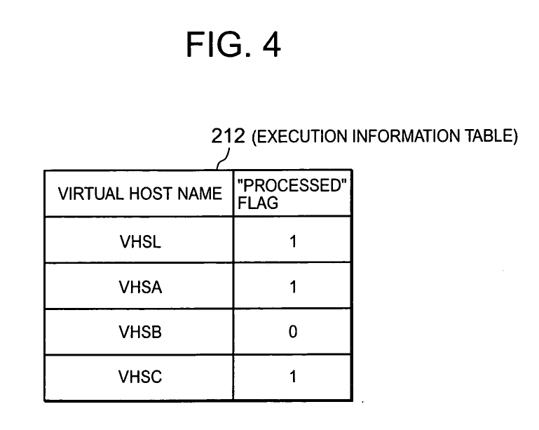

Referring to FIG. 4, the shared data area 202 stores an execution information table 212, which describes the names of the local host 11 and the virtual hosts 12 to 14, and “processed” flags indicating whether these hosts 11 to 14 are executing a job or not. The “processed” flag indicate that the job flow is being processed when it is “1, ” and that the job flow is not being processed when it is “0. ” Instead of providing the execution information table in the memory 20, the execution information table (execution information storage means) 212 may be provided in each of the local host 10 and virtual hosts 11 to 14.

Referring to FIG. 3, in each of the local host area (VHSL) 203, the area of the virtual host (VHSA) 204, the area of the virtual host (VHSB) 205, and the area of the virtual host area (VHSC) 206, a job to be executed is registered.

Referring to FIG. 1, the display device 30, which may be a liquid crystal display device or a CRT, displays the execution status of the job management system or operating instructions, etc.

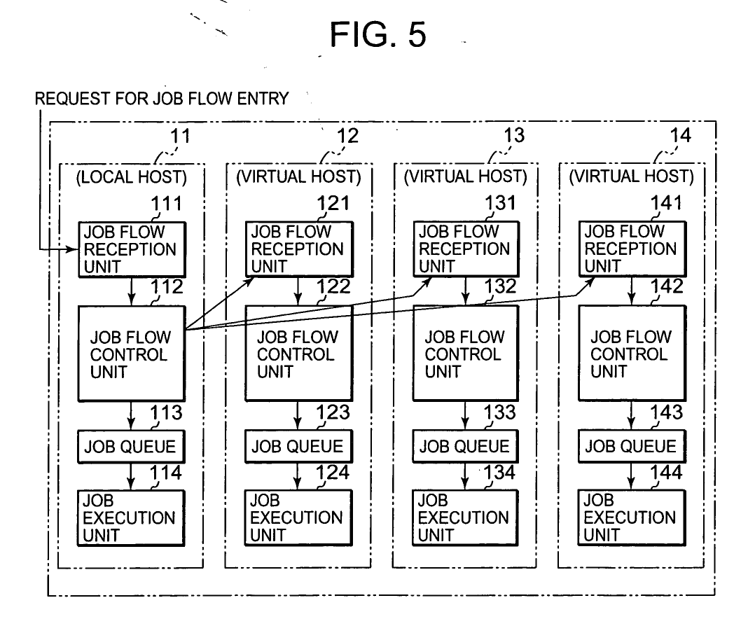

Referring to FIG. 5, the job management system of this embodiment includes the local host 11 and the virtual hosts 12, 13 and 14 which include the job flow control threads 11a to 14a , respectively. The job flow control threads 11a to 14a are caused to execute the job management program. More specifically, the local host (VHSL host) 11 generates a job flow reception unit 111, a job flow control unit (destination determination element, job flow transfer element) 112, a job queue (job storage element) 113, and a job execution unit (job execution means) 114. The job flow control unit 112 determines the destination of the job flow and transfers the job flow. The job queue (job storage element) 113 stores a job.

The virtual host (VHSA host) 12 generates a job flow reception unit 121, a job flow control unit (job specification means) 122, a job queue (job storage means) 123, and a job execution unit (job execution means) 124. The virtual host (VHSB host) 13 generates a job reception unit 131, a job flow control unit (job specification means) 132, a job queue (job storage means) 133, and a job execution unit (job execution means) 134. The virtual host (VHSC host) 14 also generates a job flow reception unit 141, a job flow control unit (job specification means) 142, a job queue (job storage means) 143, and a job execution unit (job execution means) 144.

In local host 11, the job reception unit 111 receives a job flow entered from the outside and outputs the job flow to the job flow control unit 112. The job flow control unit 112 analyzes the entered job flow and determines whether or not the local host (VHSL host) 11 is executing a job with reference to the execution information table 212. If local host (VHSL host) 11 is executing the job, the job flow control unit 112 refers to the. execution information table 212 in the memory 20 to find a virtual host which is not executing a job and transfers the job flow to the host. On the other hand, if local host (VHSL host) 11 is not executing the job, the job flow control unit 112 changes the “processed” flag corresponding to the local host (VHSL host) 11 from “0” to “1” and analyzes the entered job flow and stores the job in the local host area (VHSL) of the memory 20. The job queue 113 stores a program for executing the job flow. The job execution unit 114 executes the program stored in the job queue 113, in turn.

The job reception unit 121 of the virtual host (VHSA host) 12, the job reception unit 131 of the virtual host (VHSB host) 13, and the job reception unit 141 of the virtual host .(VHSC host) 1.4 receive the entered jobs from job flow control unit 112 and output the jobs to the corresponding job flow control units 122 to 142, respectively. The job flow control unit 122 of the virtual host (VHSA host) 12, the job flow control unit 132 of the virtual host (VHSB host) 13, and the job flow control unit 142 of the virtual host (VHSC host) 14 analyze the job flow when it is entered, and store a job which should be processed in the memory 20, respectively. Further, the job queue 123 of the virtual host (VHSA host) 12, the job queue 133 of the virtual host (VHSB host) 13, and the job queue 143 of the virtual host (VHSC host) 14 store a program for executing the job, respectively. Then the job execution units 124 to 144 execute the program stored in the corresponding job queues 123 to 143.

Next, the operation of the job management system according to this embodiment will be described.

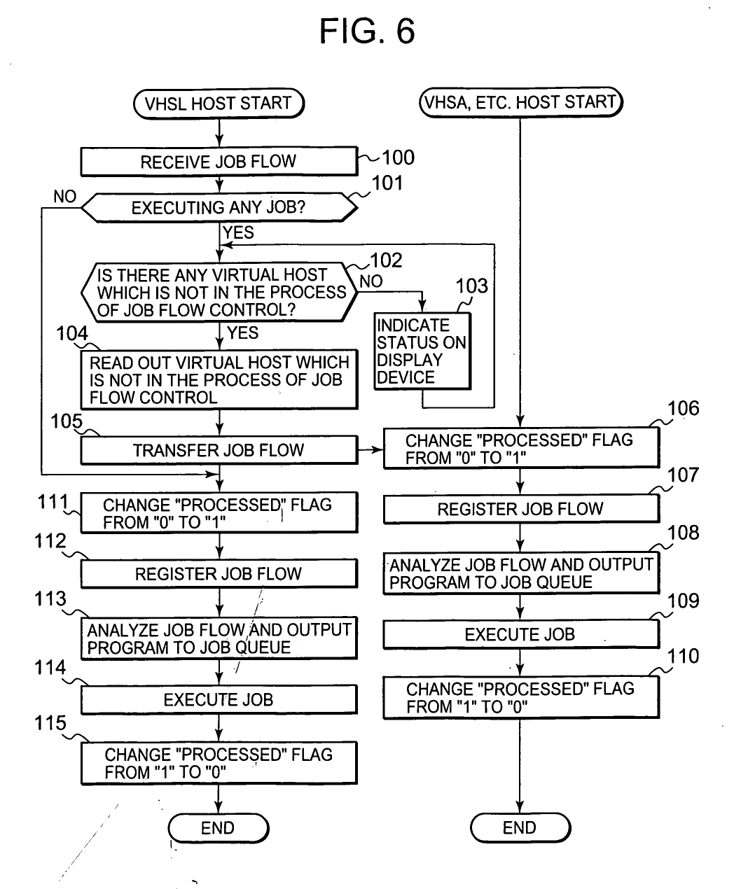

In FIG. 6, when a request for job flow entry is input by a client, etc. from the outside, the job reception unit 111 of the local host (VHSL host) 11 receives the job flow (step 100: job flow reception step), and outputs the job flow to the job flow control unit 112. The job flow control unit 112 of the local host (VHSL host) 11 refers to the “processed” flag which is hold for each virtual host name in the execution information table 212 to determine whether or not the local host (VHSL host) 11 is in the process of any job flow control (step 101). If it is determined that the local host (VHSL host) 11 is actually in the process of job flow control because the “processed” flag of the local host (VHSL host) 11 is “1” (step 101; YES), the job flow control unit 112 refers to the execution information table 212 again to determine whether or not any of the virtual hosts for job processing 12, 13 or 14 is in the process of job flow control (step 102).

If it is determined that all of the virtual hosts 12, 13 or 14 is in the process of job flow control, (step 102; NO), the job flow control unit 112 of the local host (VHSL host) 11 causes the display device 30 to display, for example, “System is busy; please wait for a while,” (step 103). In this state, the same operation is continued until any of the hosts is not in the process of job flow control. On the other hand, if it is determined that any of the virtual hosts 12, 13, or 14 is not in the process of job flow control (step 102; YES), the name of the virtual host which is not in the process of job flow control is read out (step 104: job flow allocation step, destination determination step). Then, the job flow control unit 112 of the local host (VHSL host) 11 transfers jobs of the job flow to the job flow reception unit 121 of the virtual host (for example, the virtual host 12) which is read out not to be in the process of job flow control in step 104 (step 105: job flow transfer step). To similar to the virtual hosts for job processing 13 (VHSB host) and 14 (VHSC host), if the job flow control unit 132 or 142 is not in the process of job flow control, the job flow control unit 112 may transfer jobs of the job flow to the job flow reception unit 131 of the virtual host (VHSB host) 13 or the job flow reception unit 141 of the virtual host (VHSC host) 14.

The job flow reception unit 121 of the virtual host (VHSA host) 12, on receiving the job flow, changes the “processed” flag of the virtual host (VHSA host) 12 in the execution information table 212 from “0” to “1”, (step 106). Then, the job flow reception unit 121 outputs the transferred jobs of the job flow to the job flow control unit 122 . The job flow control unit 122 of the virtual host (VHSA host) 12 registers the input job flow in the area of the virtual host (VHSA) 204 in the memory 20 (step 107). The job flow control unit 122 analyzes the input job flow and outputs the program of the job name described in the job flow to the job queue 123 (step 108: job storage and control step), and prepares resources for use in program e.g. main storage areas, files, or magnetic tapes. Subsequently, the job execution unit 124 reads out the program stored in the job queue 123 and executes the job (step 109: job execution step). When the execution of the job is completed, the “processed” flag of the virtual host (VHSA host) 12 in the execution information table 212 is changed from “1” to “0” (step 110) and the results of the execution by the virtual host (VHSA host) 12 are merged by the local host (VHSL host) 11 (processing result collection step).

In step 101, if the job flow control unit 112 of the virtual host (VHSA host) 12 determines that the local host (VHSL host) 11 is actually not in the process of any job flow control because the “processed” flag of the local host (VHSL host) 11 is “0” (step 101; NO), the “processed” flag of the local host (VHSL host) in the execution information table 212 is changed from “0” to “1” (step 111). Then, the job flow control unit 112 stores the input job flow in the local host area (VHSL) 203 of the memory 20 (step 112). Then, the job flow control unit 112 analyzes the input job flow and outputs the program of the job name described in the job flow to the job queue 113 (step 113). It also prepares resources for use in program, e.g. main storage areas, files, ormagnetic tapes. Next, the job execution unit 114 reads out the program stored in the job queue 113 and executes the job (step 114). Then, the job execution unit 114, upon completion of the job execution, changes the “processed” flag of the local host (VHSL host) 11 in the execution information table 212 from “1” to “0” (step 115), and the operation is ended.

In this way, in the job management system of the embodiment as described above, the local host (VHSL host) 11, the virtual host (VHSA host) 12, the virtual host (VHSB host) 13, and the virtual host (VHSC host) 14 generated by the virtual host generation program process the jobs described in the job flow collectively. More specifically, in this embodiment, a plurality of virtual hosts are activated according to a program previously incorporated into the memory 20 and a single job management system for managing them is operated. In this embodiment, the control of the job flow and the execution of the jobs are distributed to a plurality of virtual hosts for job processing and are concurrently processed on a plurality of CPUs. Accordingly, job processing speed is improved by the efficient use of the CPUs.

Note that, in the job management system and the method of managing the jobs of the embodiment described above, the function of the local host 11 as shown in FIG. 5 is achieved by executing the generated job flow control thread 11a as shown in FIG. 2.

Next, a second embodiment of the present invention will be described in detail.

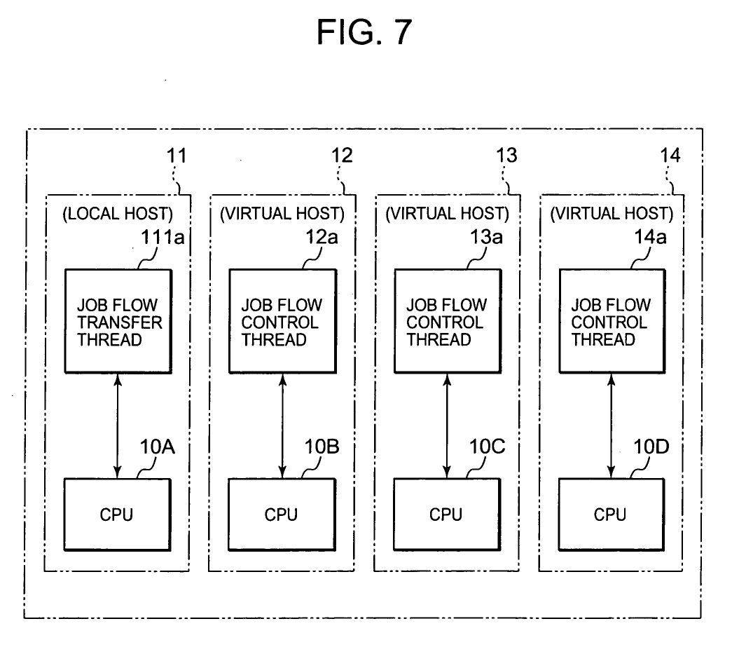

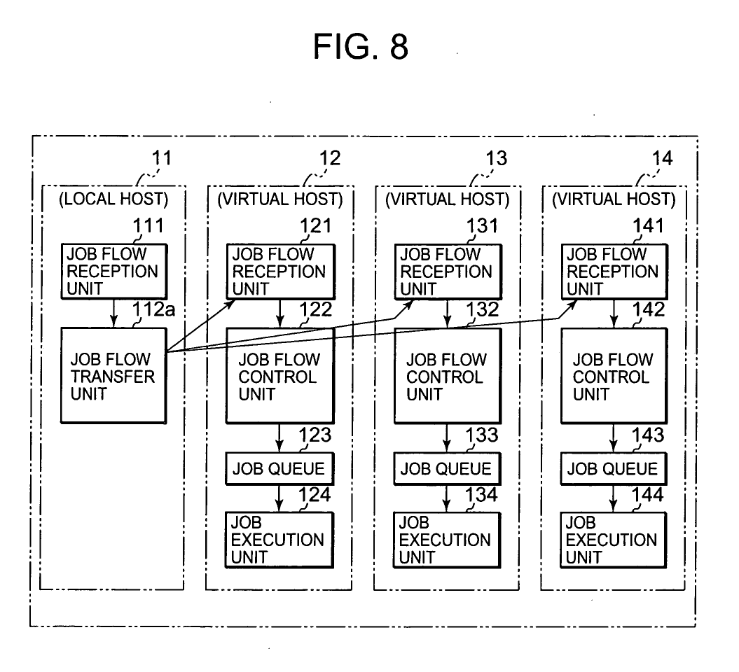

Referring to FIG. 7, a local host (VHSL host) 11 is arranged to include a job flow transfer thread 111a instead of a job flow control thread 11a of the first embodiment. The job flow transfer thread 111a has an element of referring to an execution information table 121 to check the job execution information of a virtual host (VHSA host) 12, a virtual host (VHSB host) 13, and a virtual host (VHSC host) 14, an element of transferring jobs of the job flow to any of the virtual hosts which are not in the process of job execution, and an element of merging the results of the execution by the virtual hosts. More specifically, in the job management system and the method of managing the jobs according to the second embodiment, the elements shown in FIG. 8 can be achieved by causing the job flow transfer thread 111a, and the job flow control threads 12a to 14a to execute a job management program stored in the memory 20 on a plurality of CPUs.

The job flow transfer unit (destination determination means, job transfer means) 112a of the local host (VHSL host) 11 here checks the job execution information of the virtual host (VHSA host) 12,. the virtual host (VHSB host) 13, and the virtual host (VHSC host) 14 with reference to the execution information table 121 and transfers jobs of the job flow to any of the virtual hosts available for job execution. The rest of the structure of this embodiment is the same as that of the first embodiment described above. The second embodiment, similar to FIG. 5, can realize the efficient use of the plurality. of CPUs, thereby can improve the job processing speed.

While this invention has been described in conjunction with the preferred embodiments described above, it will now be possible for those skilled in the art to put this invention into practice in various other manners.

What is claimed is:

1. A job management system comprising:
a first processor element which receives a job flow; and
a second processor element,
wherein said first processor element includes:
a first element which generates first and second virtual hosts, wherein said first and second virtual hosts correspond to said first and second processor elements, respectively, and execute a job; and
a second element which, as said first virtual host allocates the jobs of said job flow to said first and second virtual hosts and which merges the results of the execution by said first and second virtual hosts.

2. The job management system according to claim 1, wherein second process or element as said second virtual host comprises:
a reception element which receives a job transferred from said first virtual host;
a storage element which stores the job received by said reception element in a queue; and
an execution element which executes the job stored by said storage element.

3. The job management system according to claim 1, further comprising:
an execution information storage element which stores information indicating whether or not each of said first and second virtual hosts are executing a job, and
wherein said second element comprises:
a reception element which receives said job flow;
a destination determination element which determines the destination of jobs of said job flow received by said reception element with reference to said information; and
a transfer element which transfers said job to the destination.

4. The job management system according to claim 3, wherein said second virtual host comprises:
a reception element which receives a job transferred from said first virtual host;
a storage element which stores the job received by said reception element in a queue, and
an execution element which executes the job stored by said storage element.

5. The job management system according to claim 4,
wherein said second element is a thread; and
wherein said second virtual host further comprises a thread for executing said reception element, said storage element, and said execution element.

6. A method of managing jobs between a first process or element which receives a job flow and a second processor element, comprising:
generating, by said first processor element, first and second virtual hosts, wherein said first and second virtual hosts correspond to said first and second processor elements, respectively, and execute a job;
allocating, by said first processor element as said first virtual host, the jobs of said job flow to said first and second virtual hosts; and
merging, by said first processor element as said first virtual host, the results of the execution by said first and second virtual hosts.

7. The method according to claim 6, further comprising:
receiving, by said second virtual host, a job transferred from said first virtual host;
storing, by said second virtual host, the job received during said receiving step in a queue; and
executing, by said second virtual host, the job stored during said storing step.

8. The method according to claim 6, wherein said allocating step comprising:
receiving said job flow;
determining the destination of jobs of said job flow with reference to previously stored information which indicates whether or not each of said first and second virtual hosts are executing a job; and
transferring said job to the determined destination.

9. The method according to claim 8, further comprising:
receiving, by said second virtual host, a job transferred from said first virtual host;
storing, by said second virtual host, the job received during said receiving step in a queue; and
executing, by said second virtual host, the job stored during said storing step.

10. A computer readable medium recording thereon a program for enabling a first computer element to execute a job management method which manages a job between said first processor element which receives a job flow and a second processor element, said job management method comprising:
generating, by said first processor element, first and second virtual hosts, wherein said first and second virtual hosts correspond to said first and second processor elements, respectively, and execute a job;
allocating, by said first processor element as said first virtual host, the jobs of said job flow to said first and second virtual hosts; and
merging, by said first processor element as said first virtual host, the results of the execution by said first and second virtual hosts.
